(19) United States
(12) Patent Application Publication
(10) Pub. No.: US 2022/0183403 A1
(43) Pub. Date: Jun. 16, 2022

(54) High-Power Heating Suit Compatible with Fast Charging Mobile Power Supply

(71) Applicant: Zhenglie LI, Shenzhen City (CN)

(72) Inventor: Zhenglie LI, Shenzhen City (CN)

(21) Appl. No.: 17/120,263

(22) Filed: Dec. 14, 2020

(51) Int. Cl. A41D 13/005; H05B 3/34; H02J 7/00

(52) U.S. Cl. CPC A41D 13/0051; H05B 3/342; H05B 2203/036; H05B 2203/035; H02J 7/0044

(57) ABSTRACT

A high-power heating suit compatible with fast charging mobile power supply includes a suit for users to wear, wherein an inner layer of the suit is arranged with a heating element in the form of a sandwich, a surface of the suit is provided with a removable mobile power supply, and the heating element is equipped with a USB power cord to connect the mobile power supply for power, and the USB power cord adopts a USB connector that supports fast charging protocol identification; the mobile power supply further equipped with an integrated module, a USB charging interface, and a USB power supply interface; the integrated module is embedded inside with a fast charging protocol that supports the USB charging interface and the USB power supply interface; an output power of the heating element can reach up to 28 W, which can reach the temperature making the user feel comfortable.

### BACKGROUND OF THE INVENTION

The utility model relates to the technical field of electric heating, in particular, to a high-power heating suit compatible with fast charging mobile power supply.

The heating suit on the market mostly uses heating elements embedded in the inner layer of the suit. The heating elements are distributed in various parts of the suit and then heated by lithium batteries. In traditional solutions, the heating suit integrates the battery on the suit, resulting in a large net weight of the suit, which is not suitable for daily wear without heating, so that it is not convenient to maintain the battery and temperature control system separately.

In view to the above problems, the industry has proposed an iterative technology that uses mobile power supply as a heating suit. The mobile power supply is a portable charger that integrates power supply and charging functions, which can charge mobile devices anytime and anywhere. With the development of mobile power supply, users are not only satisfied with the charging function, but also more users pursue safety and personality; in particular, applying the mobile power supply in the field of heating suit should be researched and developed in accordance with the temperature control system of the heating suit and the safety of use.

According to the applicant's research, in the prior art, the maximum power of the mobile power supply used in heating suit is mostly 10 W, and the output of the mobile power supply is 5V. Generally, the designed load for the heating element of the heating suit is a minimum of 2.5 ohms, so that the maximum output power of the mobile power supply may not exceed 10 W. For colder areas, in order to reach the user's conscious and comfortable body temperature as soon as possible, the heating element of the heating suit is required to work at high power to obtain higher temperature and faster heating speed.

In view of the above situations, obviously, the mobile power supply used in the heating suit in the prior art cannot provide matching power support for the heating element of the heating suit.

### BRIEF SUMMARY OF THE INVENTION

To satisfy the above requirements of the prior art, the utility model provides a high-power heating suit compatible with fast charging mobile power supply, which provides adjustable output power higher than 10 W for the heating suit based on fast charging protocol, so as to reach the user's conscious and comfortable body temperature as soon as possible.

To achieve the above object, the utility model adopts the following technical solutions:

A high-power heating suit compatible with fast charging mobile power supply includes a suit for users to wear, wherein an inner layer of the suit is arranged with a heating element in the form of a sandwich, a surface of the suit is provided with a removable mobile power supply, and the heating element is equipped with a USB power cord to connect the mobile power supply for obtaining power;

the USB power cord adopts a USB connector that supports fast charging protocol identification, and a safety switch that controls the power on and off is connected in series in the USB power cord;

the mobile power supply has a bottom shell and a top shell, the bottom shell being a box-shaped structure with an open top surface and having an inner portion provided with a fixed-mounted lithium battery and a PCBA board, the top shell being detachably fastened to the top surface of the bottom shell to close the bottom shell;

the PCBA board is equipped with a control module, and a button module and a display module that are connected to the control module, and further with an integrated module and a battery protection module, a temperature protection module, a USB charging interface, a USB power supply interface that are connected to the integrated module, the lithium battery being connected to the PCBA board through the battery protection module to achieve electrical connection;

the button module provides at least one operation button on a side of the bottom shell;

the display module provides a display interface visible from the top surface of the top shell;

the USB charging interface and the USB power supply interface are provided on the side of the bottom shell, the USB charging interface is used to connect an external power supply to charge the lithium battery, and the USB power supply interface is used to connect the heating element of the suit or an external electrical device to provide the lithium battery as a power source;

the integrated module is embedded with a fast charging protocol that supports the USB charging interface and the USB power supply interface, so that the external power supply that supports the same fast charging protocol may quickly charge the lithium battery; the heating element of the suit is designed to have a maximum power higher than 10 W, and adopts the USB connector that supports the same fast charging protocol to be pluggably connected to the USB power supply interface of the mobile power supply, so that the heating element of the suit obtains an input voltage with an upper limit higher than 5V according to the fast charging protocol;

the control module is communicatively connected to the integrated module through an I2C bus, the button module is used to input an operation instruction to the control module, and the display module is used to display the data provided by the control module;

the temperature protection module is configured close to the lithium battery to feed back an monitoring signal corresponding to an operating temperature of the lithium battery to the integrated module; the integrated module presets a safety threshold for the operating temperature of the lithium battery, and the lithium battery is disconnected from the PCBA board when the operating temperature of the lithium battery obtained through the monitoring signal exceeds a safety threshold.

Compared with the prior arts, the beneficial effects of the present utility model are:

(1) the USB power cord configured for the heating element of the suit adopts a USB connector that supports fast charging protocol identification, which may be compatible with ordinary power supply and mobile power supply that supports fast charging protocols;

(2) the mobile power supply provides a USB power supply interface that supports the fast charging protocol, so that the heating element of the suit may obtain an input voltage higher than 5V according to the fast charging protocol, wherein an output power of the heating element may reach up to 28 W, which can reach the temperature that makes the user feel comfortable;

(3) the mobile power supply has a bottom shell and a top shell that are buckled with each other, making the assembly easier.

In the following, the utility model will be described clearly and completely with reference to the drawings and specific implementations of the specification, and the specific implementations described are only part of the embodiments of the utility model. All other embodiments obtained by those skilled in the art without creative work shall fall within the protection scope of the utility model.

### BRIEF DESCRIPTION OF THE DRAWINGS

FIG. 1 is a structure diagram of the utility model.

FIG. 2 is a structure diagram of a mobile power supply of the utility model.

FIG. 3 is an exploded diagram of the mobile power supply of the utility model.

FIG. 4 is a block scheme diagram of the mobile power supply of the utility model.

FIG. 5 is a schematic diagram of the circuit principle of a power supply interface in the utility model.

FIG. 6 is a schematic diagram of the circuit principle of a control module in the utility model.

FIG. 7 is a schematic diagram of the circuit principle of an integrated module in the utility model.

### DETAILED DESCRIPTION OF THE INVENTION

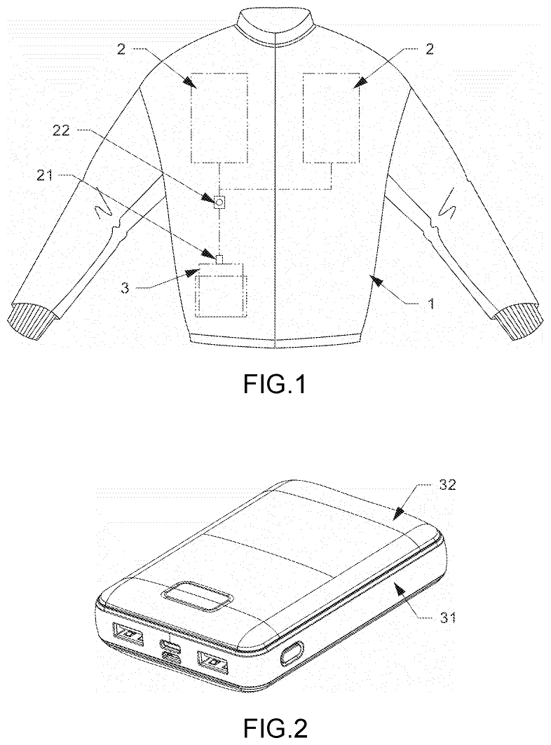

With reference to FIGS. 1 to 7,

a high-power heating suit compatible with fast charging mobile power supply includes a suit 1 for users to wear, wherein an inner layer of the suit 1 is arranged with a heating element 2 in the form of a sandwich, a surface of the suit is provided with a removable mobile power supply 3, and the heating element 2 is equipped with a USB power cord 21 to connect the mobile power supply 3 for obtaining power;

the USB power cord 21 adopts a USB connector that supports fast charging protocol identification, and a safety switch 22 that controls the power on and off is connected in series in the USB power cord 21;

the mobile power supply 3 has a bottom shell 31 and a top shell 32, the bottom shell 31 being a box-shaped structure with an open top surface and having an inner portion provided with a fixed-mounted lithium battery 33 and a PCBA board 34, the top shell 32 being detachably fastened to the top surface of the bottom shell 31 to close the bottom shell 31;

the PCBA board 34 is equipped with a control module 341, and a button module 342 and a display module 343 that are connected to the control module 341, and further with an integrated module 344 and a battery protection module 345, a temperature protection module 346, a USB charging interface 347, a USB power supply interface 348 that are connected to the integrated module 344, the lithium battery 33 being connected to the PCBA board 34 through the battery protection module 345 to achieve electrical connection;

the button module 342 provides at least one operation button 312 on a side of the bottom shell 31;

the display module 343 provides a display interface 323 visible from the top surface of the top shell 32;

the USB charging interface 347 and the USB power supply interface 348 are provided on the side of the bottom shell 31, the USB charging interface 347 is used to connect an external power supply to charge the lithium battery 33, and the USB power supply interface 348 is used to connect the heating element 2 of the suit 1 or an external electrical device to provide the lithium battery 33 as a power source;

the integrated module 344 is embedded with a fast charging protocol that supports the USB charging interface 347 and the USB power supply interface 348, so that the external power supply that supports the same fast charging protocol may quickly charge the lithium battery 33; the heating element 2 of the suit 1 is designed to have a maximum power higher than 10 W, and adopts the USB connector that supports the same fast charging protocol to be pluggably connected to the USB power supply interface 348 of the mobile power supply 3, so that the heating element 2 of the suit 1 obtains an input voltage with an upper limit higher than 5V according to the fast charging protocol;

the control module 341 is communicatively connected to the integrated module 344 through an I2C bus, the button module 342 is used to input an operation instruction to the control module 341, and the display module 343 is used to display the data provided by the control module 341;

the temperature protection module 346 is configured close to the lithium battery 33 to feed back an monitoring signal corresponding to an operating temperature of the lithium battery 33 to the integrated module 344; the integrated module 344 presets a safety threshold for the operating temperature of the lithium battery 33, and the lithium battery 33 is disconnected from the PCBA board 34 when the operating temperature of the lithium battery 33 obtained through the monitoring signal exceeds a safety threshold.

In the above embodiment, the USB power cord configured for the heating element of the suit adopts a USB connector that supports fast charging protocol identification, which may be compatible with ordinary power supply and mobile power supply that supports fast charging protocols; when an ordinary mobile power supply is used, the heating element 2 of the suit 1 does not work at full power, but it may still generate heat.

When a mobile power supply that supports fast charging protocol, e.g., QC3.0 fast charging protocol, is used, in the above embodiment, the mobile power supply 3 provides the USB power supply interface 348 that supports QC3.0; since the heating element 2 of the suit 1 is designed to have a maximum power higher than 10 W, and adopts a USB connector that supports QC3.0, which is pluggable and connects to the USB power supply interface 348 of the mobile power supply 3, the heating element 2 of the suit 1 obtains an input voltage with an upper limit higher than 5V according to QC3.0, and the output power thereof may reach up to 28 W, so as to reach the user's consciously comfortable temperature as soon as possible.

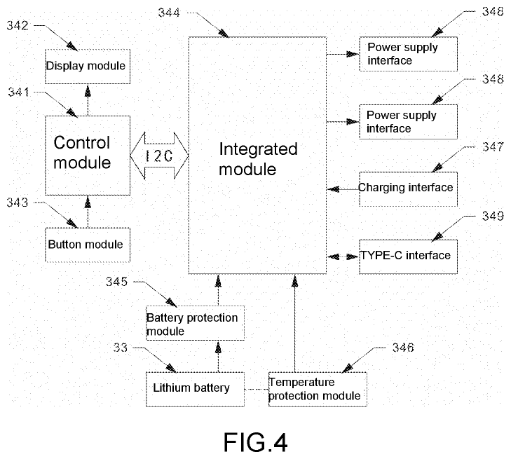

In a preferable embodiment, as shown in FIG. 4, the USB charging interface 347 selects Micro-USB, and the USB power supply interface 348 selects USB-A.

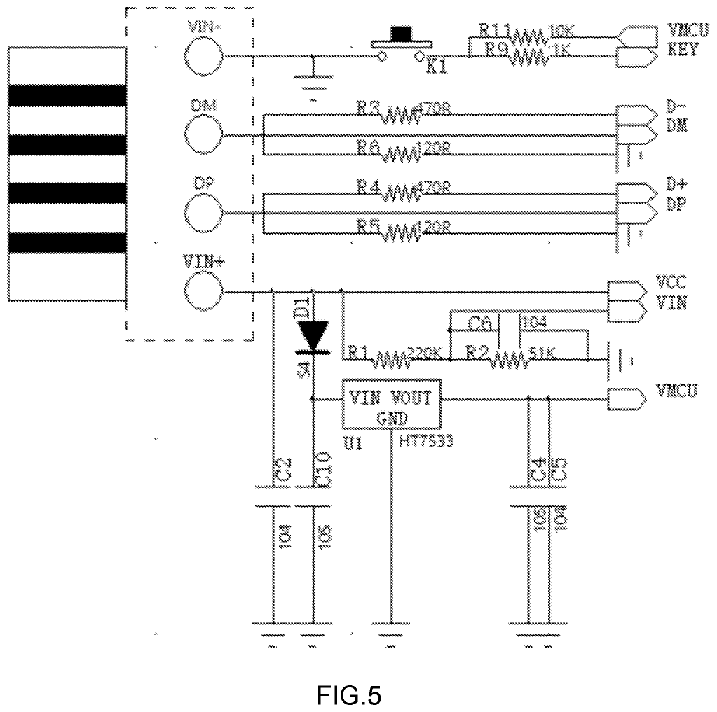

In a preferable embodiment, as shown in FIG. 5, when the USB power supply interface 348 selects USB-A, a pin 1 and a pin 4 of the USB power supply interface 348 are defined as VIN+ and VIN− respectively to form an external DC power output terminal, and a pin 2 and a pin 3 of the USB power supply interface 348 are defined as DM and DP respectively to form a communication terminal supporting the fast charging protocol.

In a preferable embodiment, as shown in FIGS. 2 to 4, the USB power supply interface 348 has at least two interfaces with independent outputs.

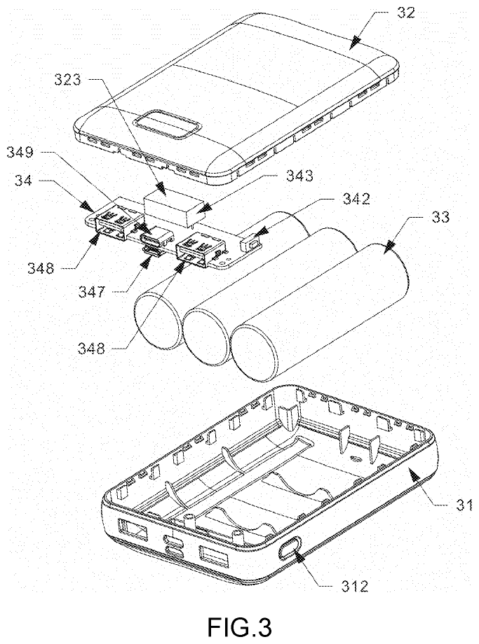

In a preferable embodiment, as shown in FIGS. 3 to 4, the PCBA board 34 is further equipped with a TYPE-C interface 349 on the side of the bottom shell 31 for connecting an external device connected by TYPE-C to the mobile power supply 3; and the integrated module 344 is built inside with a circuit logic that communicates with the external device connected by TYPE-C mode through the TYPE-C interface 349 to distinguish whether the external device is the external power supply or the external electric device. Further, in this way, all of the TYPE-C interfaces 349 are supported by the fast charging protocol embedded in the integrated module 344 to adapt to the external device that also supports the same fast charging protocol.

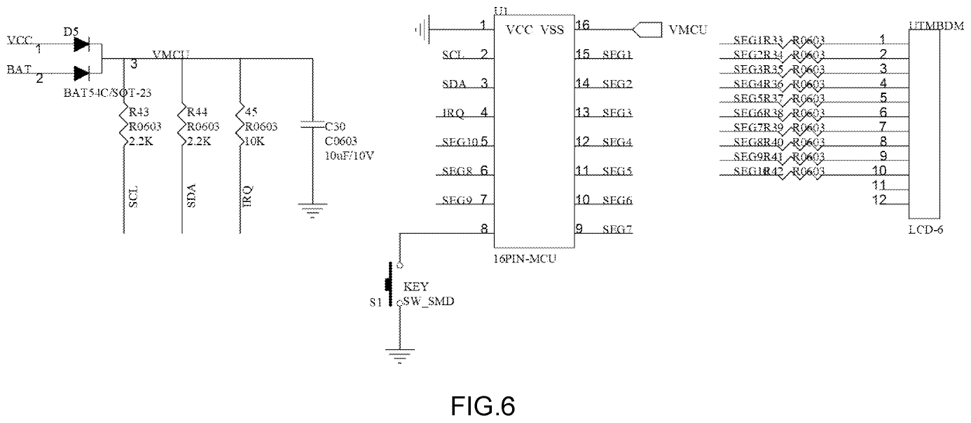

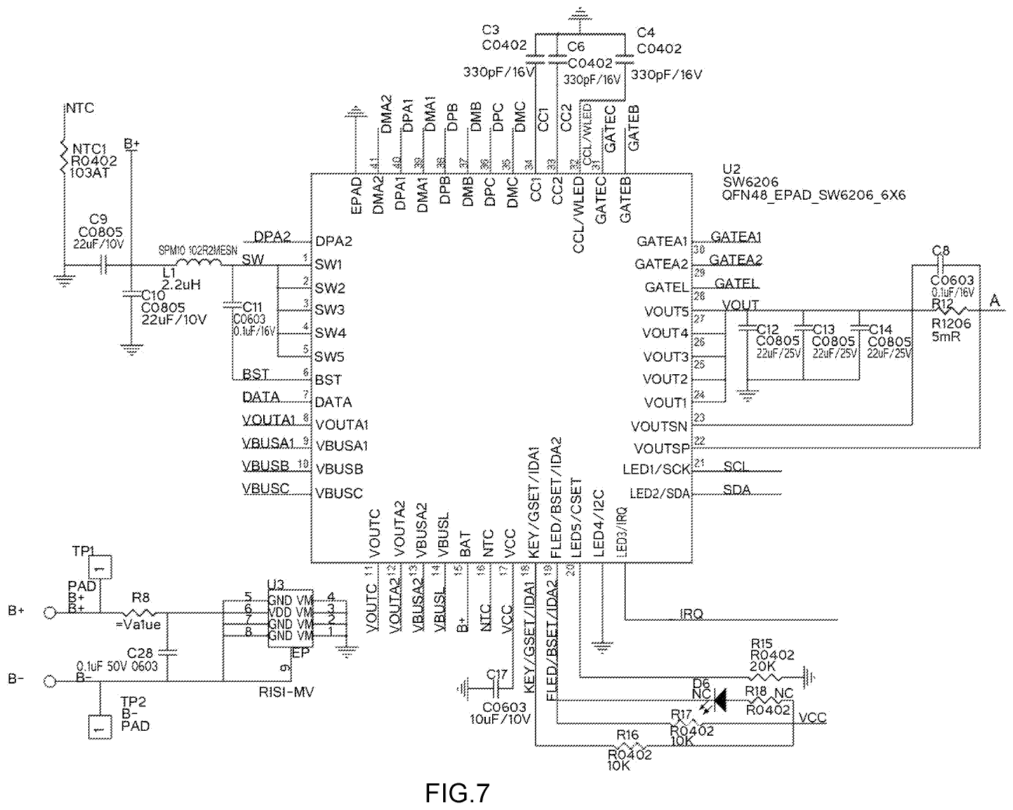

In order to facilitate a clear understanding of the implementation of the utility model, FIGS. 6 and 7 provide an exemplary circuit structure of the mobile power supply 3 in the utility model. As shown in FIGS. 6 and 7, in a preferable embodiment, the control module 341 is constructed with a chip with a model of CSU8RP3215, the display module 343 is constructed with a digital display tube with a model of KHP19092CR15, the integrated module 344 is constructed with a chip with a model of SW6206, the battery protection module 345 is constructed with a chip with a model of XB8989A, and the temperature protection module 346 is constructed with a thermistor with a model of 103AT. In view of the chip characteristics of SW6206, the integrated module 344 may adopt conventional technical means to build in circuit logics such as providing DC-DC voltage conversion, overvoltage protection, overcurrent protection, short circuit protection, overcharge protection, and overdischarge protection for lithium batteries.

As an improvement of the solution in the utility model, the top shell 32 is made of translucent material. Therefore, the top shell 32 directly visualizes the display interface 323 of the display module 343 without opening additional windows, so as to provide better sealing protection for the inside of the bottom shell 31.

In order to realize the power adjustment of the heating suit, the control module 341 is triggered by the operation button 312 of the button module 342 to send a square wave control signal to the integrated module 344, and the integrated module 344 increases/decreases an output voltage of the power supply interface 348 in units of 200 mV according to the square wave control signal.

For those skilled in the art, it is apparent that the utility model is not limited to the details of the above-mentioned exemplary embodiments, and the utility model can be implemented in other specific forms without departing from the spirit or basic features of the utility model. Therefore, all modifications falling within the meaning and scope of equivalent elements of the claims are included in the utility model.

What is claimed is:

1. A high-power heating suit compatible with fast charging mobile power supply, including a suit for users to wear, an inner layer of the suit being arranged with a heating element in the form of a sandwich, a surface of the suit being provided with a removable mobile power supply, the heating element being equipped with a USB power cord to connect the mobile power supply for obtaining power;
wherein
the USB power cord adopts a USB connector that supports fast charging protocol identification, and a safety switch that controls the power on and off is connected in series in the USB power cord;
the mobile power supply has a bottom shell and a top shell, the bottom shell being a box-shaped structure with an open top surface and having an inner portion provided with a fixed-mounted lithium battery and a PCBA board, the top shell being detachably fastened to the top surface of the bottom shell to close the bottom shell;
the PCBA board is equipped with a control module, and a button module and a display module that are connected to the control module, and further with an integrated module and a battery protection module, a temperature protection module, a USB charging interface, a USB power supply interface that are connected to the integrated module, the lithium battery being connected to the PCBA board through the battery protection module to achieve electrical connection;
the button module provides at least one operation button on a side of the bottom shell;
the display module provides a display interface visible from the top surface of the top shell;
the USB charging interface and the USB power supply interface are provided on the side of the bottom shell, the USB charging interface is used to connect an external power supply to charge the lithium battery, and the USB power supply interface is used to connect the heating element of the suit or an external electrical device to provide the lithium battery as a power source;
the integrated module is embedded with a fast charging protocol that supports the USB charging interface and the USB power supply interface, so that the external power supply that supports the same fast charging protocol may quickly charge the lithium battery; the heating element of the suit is designed to have a maximum power higher than 10 W, and adopts the USB connector that supports the same fast charging protocol to be pluggably connected to the USB power supply interface of the mobile power supply, so that the heating element of the suit obtains an input voltage with an upper limit higher than 5V according to the fast charging protocol;
the control module is communicatively connected to the integrated module through an I2C bus, the button module is used to input an operation instruction to the control module, and the display module is used to display the data provided by the control module;
the temperature protection module is configured close to the lithium battery to feed back an monitoring signal corresponding to an operating temperature of the lithium battery to the integrated module; the integrated module presets a safety threshold for the operating temperature of the lithium battery, and the lithium battery is disconnected from the PCBA board when the operating temperature of the lithium battery obtained through the monitoring signal exceeds a safety threshold.

2. The high-power heating suit compatible with fast charging mobile power supply according to claim 1, wherein the USB charging interface adopts Micro-USB, and the USB power supply interface adopts USB-A.

3. The high-power heating suit compatible with fast charging mobile power supply according to claim 2, wherein a pin 1 and a pin 4 of the USB power supply interface are defined as VIN+ and VIN− respectively to form an external DC power output terminal, and a pin 2 and a pin 3 of the USB power supply interface are defined as DM and DP respectively to form a communication terminal supporting the fast charging protocol.

4. The high-power heating suit compatible with fast charging mobile power supply according to claim 1, wherein the USB power supply interface has at least two interfaces with independent outputs.

5. The high-power heating suit compatible with fast charging mobile power supply according to claim 1, wherein the PCBA board is further equipped with a TYPE-C interface on the side of the bottom shell for connecting an external device connected by TYPE-C to the mobile power supply; and the integrated module is built inside with a circuit logic that communicates with the external device connected by TYPE-C mode through the TYPE-C interface to distinguish whether the external device is the external power supply or the external electric device.

6. The high-power heating suit compatible with fast charging mobile power supply according to claim 5, wherein all of the TYPE-C interfaces are supported by the fast charging protocol embedded in the integrated module to adapt to the external device that also supports the same fast charging protocol.

7. The high-power heating suit compatible with fast charging mobile power supply according to claim 1, wherein the control module is constructed with a chip with a model of CSU8RP3215, the display module is constructed with a digital display tube with a model of KHP19092CR15, the integrated module is constructed with a chip with a model of SW6206, the battery protection module is constructed with a chip with a model of XB8989A, and the temperature protection module is constructed with a thermistor with a model of 103AT.

8. The high-power heating suit compatible with fast charging mobile power supply according to claim 1, wherein the top shell is made of translucent material.

9. The high-power heating suit compatible with fast charging mobile power supply according to claim 1, wherein the control module is triggered by the operation button of the button module to send a square wave control signal to the integrated module, and the integrated module increases/decreases an output voltage of the power supply interface in units of 200 mV according to the square wave control signal.
